(19) United States
(12) Patent Application Publication
(10) Pub. No.: US 2014/0231583 A1
(43) Pub. Date: Aug. 21, 2014

(54) Launch Device for Tube-Launched Projectile

(71) Applicant: Itzhak Sapir, Irvine, CA (US)

(72) Inventor: Itzhak Sapir, Irvine, CA (US)

(21) Appl. No.: 13/769,430

(22) Filed: Feb. 18, 2013

(51) Int. Cl. B64F 1/04

(52) U.S. Cl. CPC B64F 1/04
USPC 244/63

(57) ABSTRACT

A device for launching a projectile from the bore of a tube. A launch frame having a longitudinal axis is configured for being received within the bore of the tube with a shuttle assembly configured for urging a projectile alone the tube's longitudinal axis. A shuttle assembly tensioning means is configured to urge the shuttle assembly along the longitudinal axis and a shuttle assembly retention means is configured for the selective retention and release of the shuttle assembly at a predetermined position along the longitudinal axis.

### CROSS-REFERENCE TO RELATED APPLICATIONS

This application claims the benefit of U.S. Provisional Patent Application No. 61/600,106, filed on Feb. 17, 2012 entitled “Spring-Powered Launcher for Tube-Launched UAV” pursuant to 35 USC 119, which application is incorporated fully herein by reference.

### STATEMENT REGARDING FEDERALLY SPONSORED RESEARCH AND DEVELOPMENT

N/A

### BACKGROUND OF THE INVENTION

1. Field of the Invention

The invention relates generally to the field of launch devices and mechanisms. More specifically, the invention relates to a compact, high-efficiency, spring-powered launching device for use with, for instance, a tube-launched micro-unmanned aerial vehicle.

2. Description of the Related Art

There is a need in specialized applications, military or commercial, to launch a projectile such as a small or micro-Unmanned Aerial Vehicle (UAV) from the bore of a tube such as an existing weapon tube bore.

Such a UAV launch application is disclosed in U.S. Pub. No. 2011/0168838, entitled “Launch Tube Deployable Surveillance and Reconnaissance System” to Hornback et al., filed on Apr. 21, 2010 and assigned to ISC8 Inc., assignee of the instant application.

In such tube-launched applications, the UAV is inserted inside a tube or weapon bore with its wings folded and the flight control systems in ready mode. A launch mechanism is provided to propel the UAV along the longitudinal axis of the bore and “push” the UAV or other projectile out of the tube with sufficient initial kinetic energy to permit time for the UAV wings to open and for the propulsion system to power up so that the UAV can transition to self-powered flight.

The invention disclosed herein addresses the need for such a launch mechanism.

Two types of prior art systems for launching a UAV from a tube are known to be in use.

The first type utilizes a high-pressure pneumatic system and the second type uses a controlled-explosion system.

The pneumatic system uses pressurized gas (air or nitrogen) in a tank that, upon the initiation of launch, opens a valve such that a piston is pushed inside a cylinder. This, in turn propels the UAV out of the muzzle of the tube.

The second controlled-explosion type uses one or more chemical cartridges such as the type used to instantaneously inflate automobile airbags. In this system, the UAV launch is achieved by firing the cartridge (or several cartridges in sequence) into a cylinder to push a piston that, in turn, propels the UAV out of the tube.

The main disadvantage of the first approach is logistical, i.e., there is a need to have access to high pressure gas tanks or to high pressure pumps to charge the system in locations such as combat zones where access is limited.

The second approach has the same deficiencies as the above, is costly (the cost of airbag cartridges) and requires relatively long preparation time between launches.

What is needed is a launch device that overcomes the deficiencies of the prior art tube-launching devices

### BRIEF SUMMARY OF THE INVENTION

A spring-powered launcher is provided to permit the launching of a projectile from the bore of a tube such as launching a UAV or UAS from the bore of a weapons tube which may include launching from the bore of a TOW missile tube launcher.

In a first aspect of the invention, a device for launching a projectile from the bore of a tube is disclosed comprising a launch frame having a longitudinal axis and configured for being received within the bore of the tube and comprising a shuttle assembly configured for urging a projectile along the longitudinal axis, a shuttle assembly tensioning means configured to urge the shuttle assembly along the longitudinal axis and a shuttle assembly retention means configured for the selective retention and release of the shuttle assembly at a predetermined position along the longitudinal axis.

In a second aspect of the invention, at least one of the shuttle assembly tensioning means is a helical spring element.

In a third aspect of the invention, a device for launching a projectile from the bore of a tube is disclosed comprising a launch frame having a longitudinal axis and configured for being received within the bore of the tube. The launch frame may comprise a first plate fixedly connected to a second plate. The launch frame further comprises an arming fork guide shaft, a threaded arming shaft, an arming fork slideably disposed on the guide shaft and threadably disposed on the arming shaft. The device may further comprise a shuttle shaft, a shuttle assembly slideably disposed on the shuttle shaft and that is configured to guide the travel of, and urge, a projectile along the longitudinal axis. The device may further comprise a shuttle assembly tensioning means configured to urge the shuttle assembly toward the second plate along the longitudinal axis. The shuttle assembly and arming fork are configured whereby the arming fork urges the shuttle assembly toward the first plate against a tension introduced by the tensioning means (which may comprise a helical spring tensioning element) when the arming shaft is rotated in a predetermined direction. The device may comprise shuttle assembly retention means configured for the selective retention and release of the shuttle assembly at a predetermined position on the shuttle shaft such as a mechanical retention assembly or electro-mechanical retention and triggering assembly.

An exemplar retention assembly in a preferred embodiment may comprise a Kwik-Lok pin as is available from Jergens Manufacturing. The shuttle assembly tensioning means may comprise a helical spring element.

While the claimed apparatus and method herein has or will be described for the sake of grammatical fluidity with functional explanations, it is to be understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112, are to be accorded full statutory equivalents under 35 USC 112.

### BRIEF DESCRIPTION OF THE SEVERAL VIEWS OF THE DRAWINGS

FIG. 1 is an isometric view of a launch device of the invention.

FIG. 1A is a cross-section of a view of FIG. 1.

FIG. 2 is a cross-section of the retention/release trigger portion of the launch device of the invention.

The invention and its various embodiments can now be better understood by turning to the following detailed description of the preferred embodiments which are presented as illustrated examples of the invention defined in the claims. It is expressly understood that the invention as defined by the claims may be broader than the illustrated embodiments described below.

### DETAILED DESCRIPTION OF THE INVENTION

Turning now to the figures wherein like numerals define like elements among the several views, the launch device of invention is a mechanical-tension, spring-based system. It may be prepared and armed quickly in the field by turning a threaded arming shaft manually or with a portable drill or tool so that no outside logistical support is needed. No such solution is known to be used in the prior art.

The invention provides a device for launching a projectile from the bore of a tube having a longitudinal axis which may include, by way of example, the bore of an existing weapons launch tube such as a TOW missile tube having a predetermined circular bore or equivalent structure as may be found on certain military vehicles or weapons systems

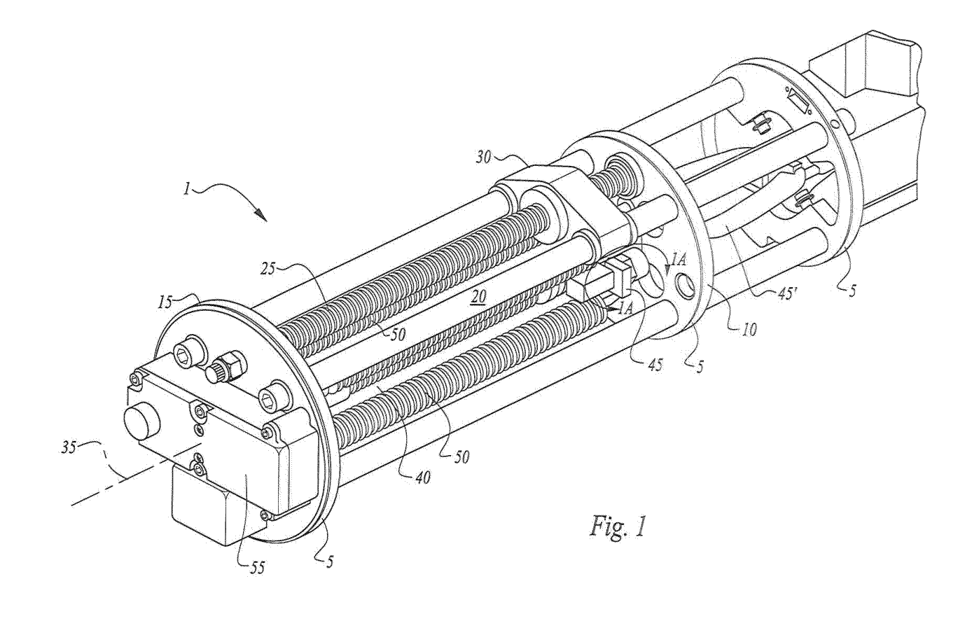

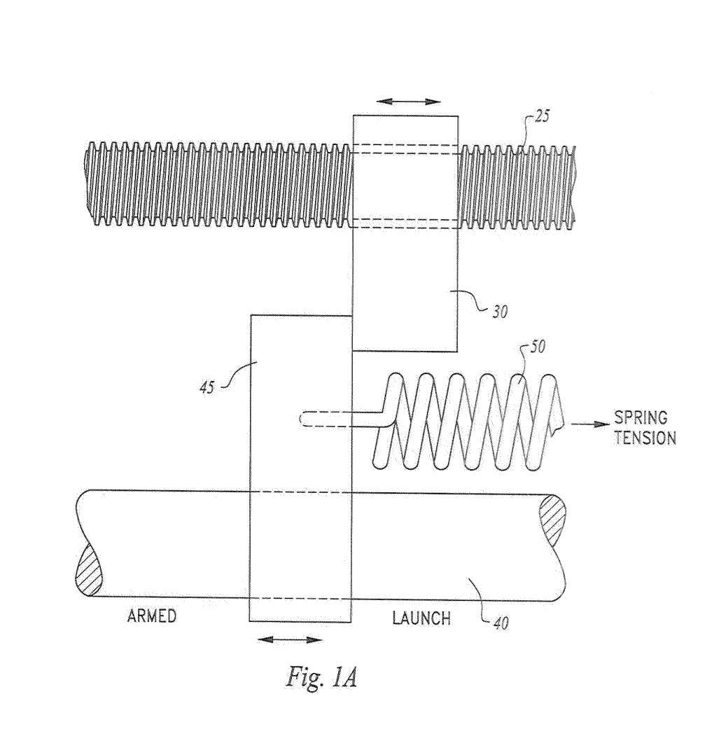

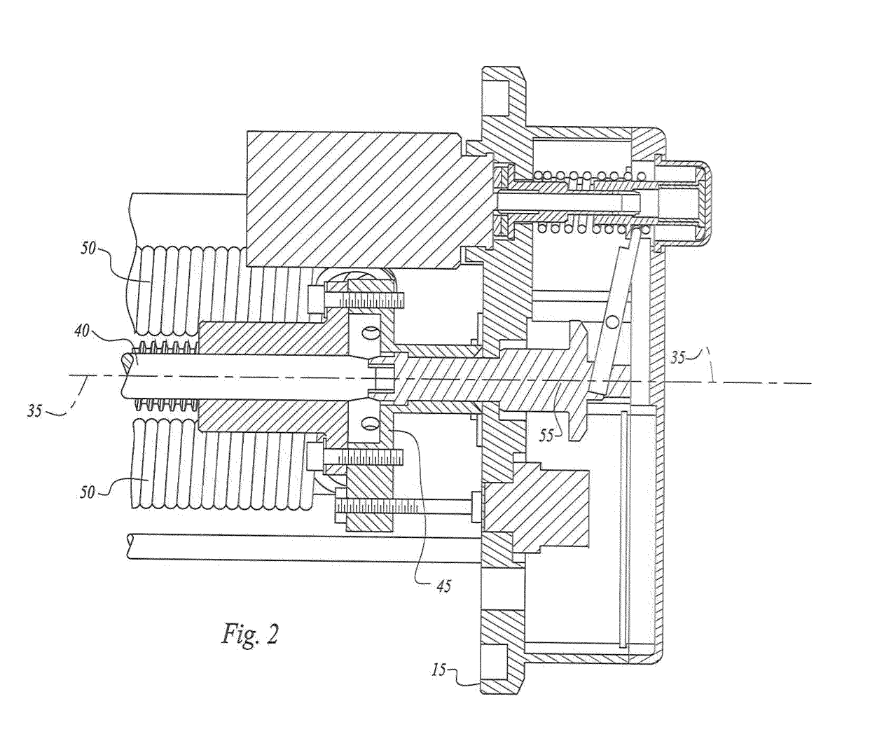

With respect to FIGS. 1, 1A and 2, a preferred embodiment of the device of the invention 1 is depicted and is comprised of a launch frame 5 configured for being received within the bore of the tube comprising a first plate 10 fixedly connected to a second plate 15. First plate 10 and second plate 15 may comprise a generally circular circumference substantially that of the interior diameter of the bore so as to be capable of being slideably received within the bore but snuggly received therein.

Launch frame 5 further comprises an arming fork guide shaft 20, a threaded arming shaft 25, and an arming fork 30 slideably disposed on the guide shaft such as with a linear shaft bearing.

Arming fork 30 is threadably disposed on arming shaft 25 such as with a threaded bearing and configured so that the rotation of arming shaft 25 will urge arming fork 30 along guide shaft 20 and along the longitudinal axis 35 of launch frame 5 which is configured to be substantially that of the bore within which device 1 is disposed.

A shuttle shaft 40 is disposed preferably with its longitudinal axis substantially along longitudinal axis 35.

A shuttle assembly 45 is slideably disposed on shuttle shaft 40 and configured for urging a projectile along longitudinal axis 35 and may include a pair of fixedly connected projectile shafts 45′ for physically urging the projectile along longitudinal axis 35 in a launch process.

A shuttle assembly tensioning means 50 is configured to urge the shuttle assembly toward second plate 15 along longitudinal axis 35. Shuttle assembly tensioning means 50 is preferably comprised of one or more helical springs.

Shuttle assembly 45 and arming fork 30 are configured whereby arming fork 30 urges shuttle assembly 45 toward first plate 10 and against the mechanical tension introduced by the tensioning means 50 when arming shaft 25 is rotated in a predetermined direction (i.e., the device is “wound up” and armed). Rotation of arming shaft 25 may be performed manually or by mechanical or mechanically-assisted means such as by use of a power tool.

As shuttle assembly 45 is urged toward first plate 10 by means of the travel of arming fork 30 along guide shaft 20 in an arming process, shuttle assembly tensioning means 50 introduces a tension on shuttle assembly 45 toward second plate 15, which second plate 15 is disposed forward-most with respect to the bore muzzle.

A shuttle assembly retention means 55 may be provided proximal to first plate 5 at a predetermined position and is configured for the selective retention and release of shuttle assembly 45 when at a predetermined position on shuttle shaft 40 such as in “loaded”; i.e., a position when shuttle tensioning means 50 are in a prelaunch, armed “in-tension” position.

Assembly retention means 55 may comprise any suitable retention means such as a mechanical or electro-mechanical element for the selected retention and release of a mechanical element subject to a tension as is known in the mechanical design arts.

An exemplar mechanical retention assembly in a preferred embodiment may comprise a Kwik-Lok pin as is available from Jergens Manufacturing. The shuttle assembly tensioning means may comprise a helical spring element.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

I claim:

1. A device for launching a projectile from the bore of a tube comprising:
a launch frame having a longitudinal axis and configured for being received within the bore of the tube comprising,
a shuttle assembly configured for urging a projectile along the longitudinal axis,
shuttle assembly tensioning means configured to urge the shuttle assembly along the longitudinal axis, and,
shuttle assembly retention means configured for the selective retention and release of the shuttle assembly at a predetermined position along the longitudinal.

2. The device of claim 1 wherein at least one of the shuttle assembly tensioning means is a helical spring element.

3. A device for launching a projectile from the bore of a tube comprising:
a launch frame having a longitudinal axis configured for being received within the bore of the tube comprising a first plate fixedly connected to a second plate,
the launch frame further comprising,
an arming fork guide shaft,
a threaded arming shaft,
an arming fork slideably disposed on the guide shaft and threadably disposed on the arming shaft,
a shuttle shaft,
a shuttle assembly slideably disposed on the shuttle shaft and configured for urging a projectile along the longitudinal axis,
shuttle assembly tensioning means configured to urge the shuttle assembly toward the second plate along the longitudinal axis,
the shuttle assembly and arming fork configured whereby the arming fork urges the shuttle assembly toward the first plate against a tension introduced by the tensioning means when the arming shaft is rotated in a predetermined direction, and,
shuttle assembly retention means configured for the selective retention and release of the shuttle assembly at a predetermined position on the shuttle shaft.

4. The device of claim 3 wherein at least one of the shuttle assembly tensioning means is a helical spring element.
